(19) United States
(12) Patent Application Publication
(10) Pub. No.: US 2007/0221468 A1
(43) Pub. Date: Sep. 27, 2007

(54) Hydraulically actuated double clutch

(75) Inventors: Philip George, Wooster, OH (US); Patrick Lindemann, Wooster, OH (US); Adam Uhler, Sterling, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/726,249

(22) Filed: Mar. 21, 2007

Related U.S. Application Data
(60) Provisional application No. 60/784,654, filed on Mar. 22, 2006.

(51) Int. Cl. F16D 25/10

(52) U.S. Cl. 192/87.11

(57) ABSTRACT

A clutch apparatus including a first bearing connected to a front side of the clutch apparatus, and a second bearing connected to a cover for the clutch apparatus. The first bearing is arranged to be piloted on a front cover for a transmission and the second bearing is arranged to be piloted on a case for the transmission. A clutch apparatus including first and second plates, and a first sealing element disposed between the first and second plates and forming a seal between the first and second plates. The first and second plates form at least a portion of a first sealed fluid chamber in the clutch apparatus. A clutch apparatus including a clutch housing with a plurality of splines proximate an axial end, and a clutch cover with a plurality of radial extensions rotationally engaged with the plurality of splines. A method of assembling a clutch apparatus.

### CROSS-REFERENCE TO RELATED APPLICATIONS

This application claims the benefit under 35 U.S.C. §119(e) of U.S. Provisional Application No. 60/784,654, filed Mar. 22, 2006.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to a clutch apparatus that is radially centered with respect to a transmission, that reduces the axial space required for fluid chambers, balances thrust forces, provides a more direct torque path between housings and covers, or connects a housing and cover with a spline connection.

### BACKGROUND OF THE INVENTION

There is a long-felt need for a clutch apparatus with improved means of joining an outer cover and an outer housing, improved means of transmitting torque between a housing and a cover, improved means of piloting bearings, and improved means of providing sealing functionality in the clutch while reducing axial width of the clutch.

### BRIEF SUMMARY OF THE INVENTION

The present invention broadly comprises a clutch apparatus including a first bearing connected to a front side of the clutch apparatus, and a second bearing connected to a cover for the clutch apparatus. The first bearing is arranged to be piloted on a front cover for a transmission and the second bearing is arranged to be piloted on a case for the transmission.

The present invention also broadly comprises a clutch apparatus including first and second radially disposed elements, and a first sealing element disposed between the first and second radially disposed elements and forming a seal between the first and second radially disposed elements. The first and second radially disposed elements form at least a portion of a first sealed fluid chamber in the clutch apparatus.

The present invention further broadly comprises a clutch apparatus including a clutch housing with a plurality of splines proximate an axial end, and a clutch cover with a plurality of radial extensions rotationally engaged with the plurality of splines.

The present invention still further broadly comprises a clutch apparatus including a housing for a clutch with an axial end; a cover for the clutch connected to the housing at the axial end; and a fluid chamber at least partially enclosed by the cover. In a closed position, the clutch exerts a first force on the housing and fluid in the fluid chamber exerts a second force on the cover and the first and second forces are in communication across the connection of the housing and cover.

The present invention broadly comprises a clutch apparatus including a first housing for a first clutch; a second housing for a second clutch, the first housing connected to the second housing; a rotatable element, the first housing connected to the rotatable element; and a fluid chamber for the second clutch. In a closed position for the second clutch, the second clutch exerts a first force in a first direction on the second housing and the second housing transfers the first force to the first housing, and fluid in the fluid chamber exerts a second force, opposite the first force, on the first cover through the rotatable element.

The present invention also broadly comprises a clutch apparatus including a first hub, connected to a first clutch carrier, having a radial extension, and arranged for rotational connection to a transmission input shaft; a second hub connected to a second clutch carrier; an input hub arranged for rotational connection to an engine; and first, second, and third bearings. The input shaft is arranged to engage the radial extension, the first bearing is axially disposed between the first and second hubs, the second bearing is axially disposed between the input hub and the second hub, and the third bearing is connected to the input hub and arranged to contact a transmission cover. A torque path is formed from the shaft through the radial extension, the first hub, the first bearing, the second hub, the second bearing, the input hub, and the third bearing to the transmission cover.

The present invention also broadly comprises a method of assembling a clutch apparatus, including the steps of axially inserting a radial extension for a clutch cover through a recess formed by a spline in a clutch housing and forming a radial indent in the first spline. The indent is axially aligned with the radial extension.

It is a general object of the present invention to provide a clutch apparatus that is accurately alignable with a transmission.

It is a further general object of the present invention to provide a clutch apparatus that reduces the space required for fluid chambers in the apparatus.

It is another general object of the present invention to provide a clutch apparatus with a cover and housing connected by a spline connection.

It is yet another general object of the present invention to provide a clutch apparatus that balances thrust forces associated with closing a clutch.

It is a still further general object of the present invention to provide a method for assembling a clutch apparatus having a spline connection between a cover and a housing.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a partial cross-sectional view of a present invention double clutch with four clutch plates;

FIG. 2 is a partial cross-sectional view of a present invention double clutch with six clutch plates;

FIGS. 3A through 3D are details of area 3 shown in FIG. 1;

FIGS. 4A and 4B are details of area 3 shown in FIG. 1;

FIG. 4C is a partial back view of a separator plate;

FIG. 5 is a cross-sectional view of a present invention double clutch;

FIG. 6 is a back perspective exploded view of the double clutch shown in FIG. 5; and,

FIG. 7 is a front perspective exploded view of the double clutch shown in FIG. 5.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

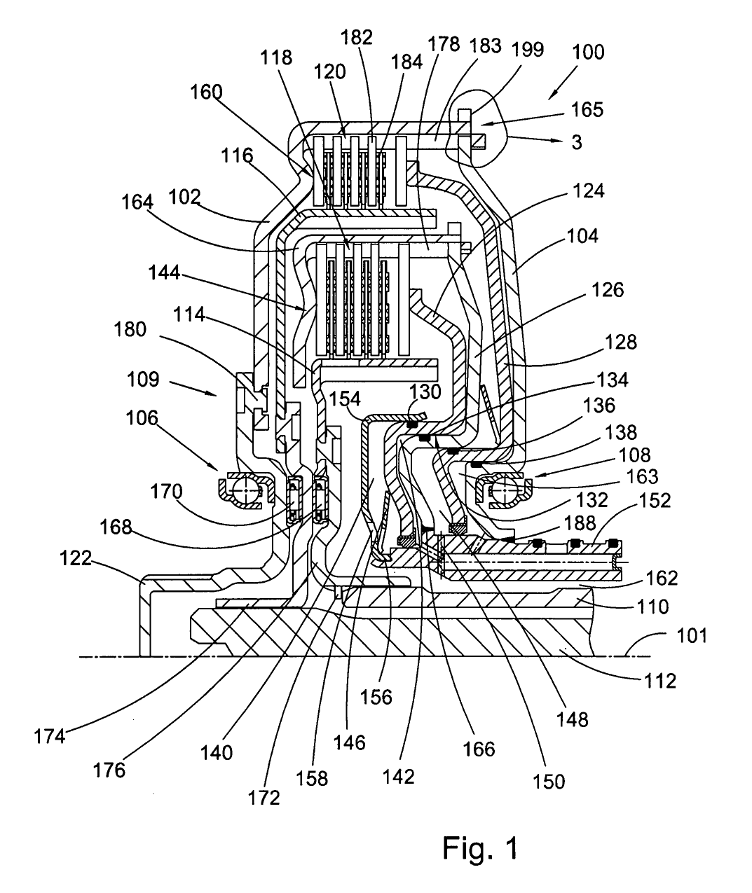

FIG. 1 is a partial cross-sectional view of present invention double clutch 100 with four clutch plates and axis 101. Centering for clutch 100 housings 102 and 104 is controlled by bearings 106 and 108, respectively. In general, bearing 106 is disposed on front side 109 of clutch 100. By front side, we mean the side facing the engine when the clutch is installed in a vehicle. Bearing 106 is piloted in the front cover of the transmission (not shown) and bearing 108 is piloted in the transmission case (not shown). Because both the transmission case and the front cover are integral to the transmission, centering is precise. Furthermore, input shafts 110 and 112 are also centered by bearings (not shown) piloted in the transmission case, so the shafts are positioned accurately relative to the housings. Transmission input shafts 110 and 112 control the position of clutch carriers 114 and 116, respectively.

Advantageously, all piloting in clutch 100 is with respect to the transmission. The controlled centering of the housings to the carriers desirably eliminates “scrubbing” of the friction material in clutch packs 118 and 120 caused by rotational/radial misalignment of the friction material, thereby reducing wear. Another advantage of assembly 100 is that the amplitude of first order vibration associated with misalignment is reduced, thereby reducing the tendency for geometric clutch shudder. In some aspects, front 109 includes input hub 122, which engages a flange for a dual mass flywheel (not shown), which accounts for any misalignment between the engine and transmission. Therefore, alignment between the engine and transmission is not as critical, reducing machining costs and the cost and complexity of the installation of the drive train.

Assembly 100 includes a plurality of radially disposed elements, for example, piston plate 124, cover 126, and piston plate 128, which along with cover 104, are interfaced with a nested seal design that reduces complexity and axial space by eliminating components. By radially disposed, we mean that at least a portion of the element is aligned orthogonal to axis 101. The seal design includes disposing a seal between two plates, two covers, or a plate and a cover to form a seal between the two plates, two covers, or a plate and a cover so that the two plates, two covers, or a plate and a cover form at least a portion of a sealed fluid chamber, as further described infra. For example, plate 124 includes seal 130 and sealing surface 132 for seal 134 in cover 126. That is, a single component, plate 124 includes both a seal and a seal surface. By nesting the seals between two plates, two covers, or a plate and a cover form, it is not necessary to add additional axial space for the combined liftoff distance of all clutches. The same configuration is used for seals 136 and 138 and piston 128 and housing 104. The seal arrangement creates sealed oil chambers, for example, chambers 140 and 142. When the clutch spins, the pressure exerted by oil in the various chambers in the clutch increases with the radial distance of the oil from axis 101. The fluid pressure in the chambers on either side of a plate or cover counteract each other and serve to equalize dynamic pressure effects by the spinning oil. For example, because piston 124 has a chamber of oil on both sides, the dynamic pressure on either axial side of the piston tends to cancel. There is a small effect due to differences in sealing diameters caused by material thickness, but the net effect serves to help release clutch 144. However, apply pressure will easily overcome the small dynamic pressure when clutch apply is commanded by the transmission. Spring 146 is used to help release the clutch. It should be understood that a seal can be connected to either of the two plates, two covers, or a plate and a cover between which it is disposed. For example, in some aspects (not shown), seal 134 is connected to plate 124.

Oil is supplied to outer piston plate dynamic chamber 148 through cross-drilled hole 150 in fluid manifold 152. Inner piston plate 124 uses sealing plate 154 to define balance chamber 140. In some aspects, the sealing plate is connected to the fluid manifold by a small crimped connection 156. Sealing plate 154 contains hole 158 designed to enable fluid flow in and out of chamber 140 and to optimize pressure balance. By controlling the size and diameter of the hole, dynamic pressure in chamber 140 can balance the dynamic pressure on the transmission side of plate 124. This is achieved by calculating the dynamic pressure on the piston plate and positioning the hole at a radial location such that the dynamic pressure would be equivalent. By radial, we mean orthogonal to axis 101. If the release tendency of outer piston plate 128 is desired, the hole could be moved radially inward to achieve the same effect.

Clutch 100 includes inner clutch 144 and outer clutch 160. In general, these are wet clutches. Wet clutches, especially launch clutches, need considerable cooling flow during engagements. In general, cooling flow is introduced through a transmission shaft and moves radially outward through clutch packs. Holes in the carriers and housings allow cooling oil to flow through clutch packs. In assembly 100, bearing 106 and 108 replace the needle bearings typically disposed between fluid manifold 152 and outer input shaft 110. Thus, bearings 106 and 108 serve to center the manifold and are disposed radially outside the manifold. Therefore, in clutch 100, there are no restrictions between fluid manifold 152 and outer input shaft 110, so considerable cooling flow can easily be introduced into clutch 100 through channel 162. The more common cantilevered design requires needle bearings which introduce a flow restriction, so additional cooling circuits have to be created in the fluid manifold to allow adequate flow.

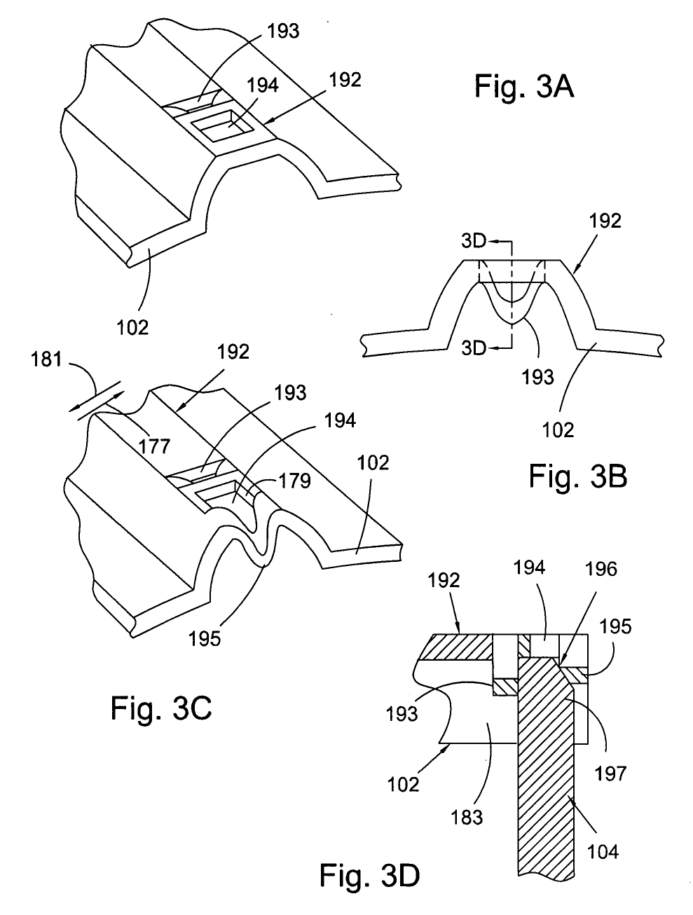

In assembly 100, when clutch 144 or 160 is applied, axial force from the piston plate 124 or 128, respectively, clamps the clutch plates in packs 118 and 120, respectively. By axial, we mean parallel to axis 101. For outer clutch 160, the resulting force is transmitted to housing 102. An opposite fluid pressure force is applied to cover 104 by fluid in chamber 163. The force from the fluid pulls on the outer housing at the indented portion described in FIG. 3 below. Thus, the force on housing 102 and the force on cover 104 are in communication along connection 165 between the housing and the cover and this communication enables the forces to balance across the housing and cover. This creates a balanced load, with minimal thrust forces transmitted to bearings in clutch 100. Similarly, thrust from inner housing 164 is transmitted to inner cover 126, which receives an opposite pressure force from chamber 142. Position of the inner cover is maintained by outer housing 102 and cover 104, through welded connections 166 and 188 at fluid manifold 152.

Outer carrier 116 is axially positioned by bearings 168 and 170 on either axial side of the carrier. Inner carrier 114 is axially positioned by bearing 168 on one side and radial protrusion 172 on the other side. In some aspects, protrusion 172 is a snap ring. Bearing 170 is axially positioned by the input hub and bearing 168 is positioned between outer clutch output hub 174 and inner clutch output hub 176. The inner clutch input hub has snap ring 172 inserted in a groove on the inside diameter to accept thrust loads from helical gears (not shown) attached to outer input shaft 110. Therefore, the thrust path for outer input shaft 110 is through the shaft, against the snap ring, into the inner clutch output hub, through bearing 168, into the outer clutch output hub, through the bearing 170, into input hub 122, through bearing 106, and into the transmission front cover (not shown).

Inner and outer housing covers 126 and 104, respectively are attached to housings 164 and 102, respectively, in a novel way, as further described infra. The housings have formed splines that the housing covers engage. For example, cover 126 engages splines 178 in housing 164. It is necessary to transmit torque through housing 102 and cover 104 to inner housing 164. The torque path flows from input hub 122, where the clutch assembly receives torque from a dual mass flywheel (not shown) and into outer housing 102 through extruded rivet attachment 180. Torque from the outer housing is transmitted to separator plates 182 by splines 183 and into clutch plates 184 when the clutch is applied. The clutch plates transmit torque through splines to outer carrier 116, into outer output hub 174, and into inner input shaft 112. The outer clutch pack is the odd gear clutch, making it the launch clutch. It should be understood that torque also can flow from the element with the cover, that is the element with the extensions, to the housing, that is, the element with the splines.

It should be understood that any means known in the art, for example, complimentary splines and notches can be used to connect clutch packs 120 and 118 to housings 102 and 164, respectively. In addition, in some aspects, a tab and slot arrangement as described in the commonly assigned U.S. Provisional Patent Application No. 60/775,622, titled “CLUTCH HOUSING WITH OPENINGS TO ENGAGE A CLUTCH PLATE, filed Feb. 22, 2006, can be used.

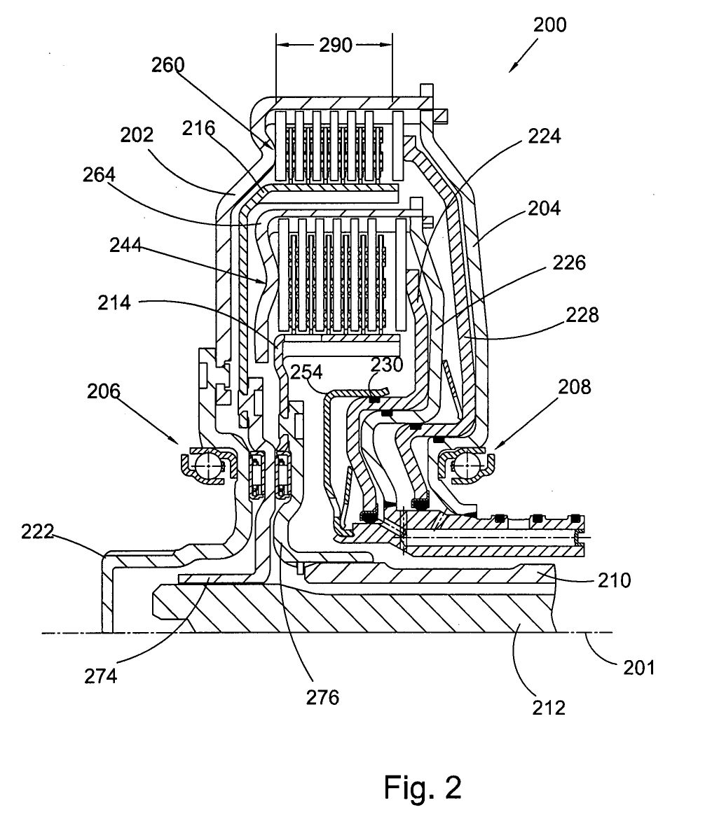

FIG. 2 is a partial cross-sectional view of present invention double clutch 200 with six clutch plates. FIG. 2 shows a design similar to FIG. 1 with the exception of the number of clutch plates. In general, the discussion regarding FIG. 1 is applicable to FIG. 2 except as noted. For example, elements 201, 202, 204, 206, 208, 210, 212, 214, 216, 222, 224, 226, 228, 230, 244, 254, 260, 264, 274, and 276 in FIG. 2 have substantially the same functionality as respective elements 101, 102, 104, 106, 108, 110, 112, 114, 116, 122, 124, 126, 128, 130, 144, 154, 160, 164, 174, and 176 in FIG. 1. That is, the respective elements are substantially equivalent. For higher torque applications, the number of clutch plates can be increased as shown in FIG. 2 and the axial length of the piston plate engagement surfaces, for example, length 290, adjusted to compensate. The remaining components remain unchanged. For the clutch in FIG. 1, this allows cost savings due to the eliminated clutch plates and separator plates, as well as economies of scale because, with the exception of the piston plates, the remaining components are the same as the higher torque application shown in FIG. 2.

FIGS. 3A through 3D are details of area 3 shown in FIG. 1. FIG. 3A is a back perspective view of cover 102, FIG. 3B is a back view of cover 102, FIG. 3C is a back perspective view of cover 102, and FIG. 3D is a cross-sectional view generally along line 3D in FIG. 3B. The following should be viewed in light of FIGS. 1 and 3A through 3D. Housing 102 receives torque from hub 122. The outer housing transmits torque through splines, further described below, into outer cover 104. The torque then travels through welded connection 188 at the fluid manifold, to inner housing cover 126 through welded connection 166, and finally into inner housing 164 through splines 178. The following discussion is applicable to the connection of housing 102 to cover 104 and the connection of housing 164 to cover 126, specifically to splines 178 and 183. For the purposes of illustration, the connection to housing 102 is described in the discussion that follows. Housing 102 includes splines 183. To control the axial position of the cover, radial indent 193 is formed on a portion of splines 183 on one side, and hole 194 and radial indent 195 on the other side. FIG. 3A shows a spline 183 before crimp 195 is formed. The radial indents extend radially inward from the cover, that is, toward axis 101. In some aspects, the assembly of clutch 100 includes the steps of inserting cover 104 into the housing spline until it contacts indent 193, and forming indent 195 on the axially opposite side of the plate to contain the cover axially. Hole 194 creates a break in the material so that radial indent 195 does not shear the housing material.

In some aspects, chamfer 196 on cover tab 197 is used to clamp the cover tight to indent 193 if indent 195 is formed at an axial distance that is less than the cover material thickness from the first indent. This clamping is desirable because it reduces potential from rattle decreasing the precision, complexity, and cost of assembling clutch 100. Also, unit loading on spline 183 is important because the connection must transmit engine torque to the inner housing, so a portion of the torque can be carried through the clamped connection, reducing unit loading on the spline teeth. In some aspects, a final step to the assembly includes rotating cover 102 to contact the drive side of the teeth to take up lash in the spline, for example, rotating the cover in direction 177 until tab 197 contacts edge 179. This rotation and engagement reduces the likelihood that a torque spike would rotate the plate through the lash, thereby loosening the clamped connection. If the outer cover teeth are already in contact with the outer housing, torque spikes will be transmitted through the teeth. It is unlikely that the clutch would see a torque spike in coast, so the clamped connection is not loosened.

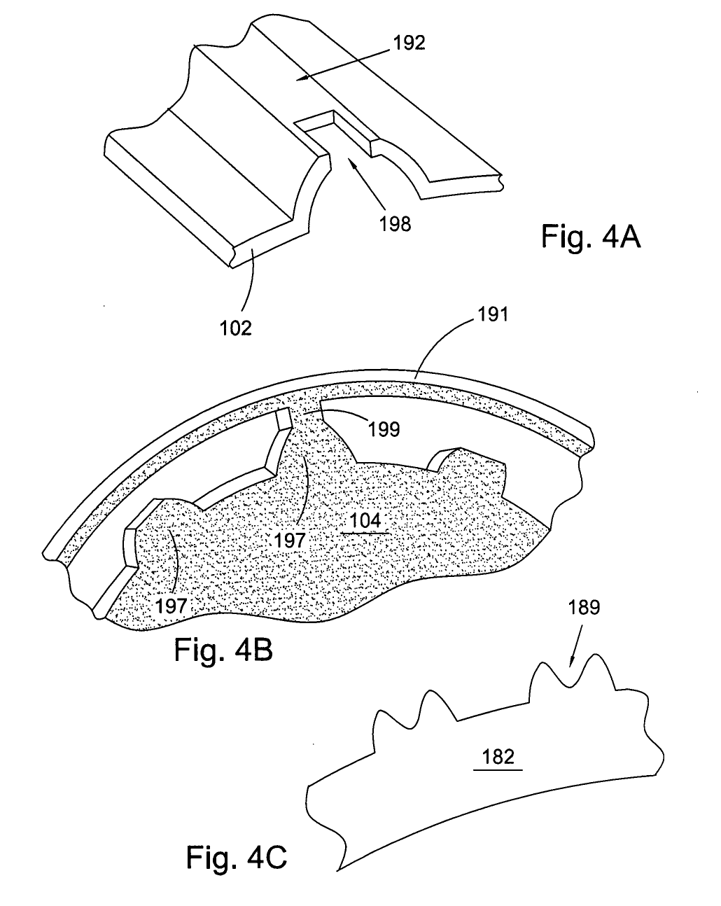

FIGS. 4A and 4B are details area 3 shown in FIG. 1. FIG. 4A is a back perspective view of housing 102 and FIG. 4B is a back perspective view of cover 104.

FIG. 4C is a back view of a separator plate. The following should be viewed in light of FIGS. 1 and 3A through 4C. Other of splines 183 are formed as shown in FIG. 4A and other of tabs 197 are formed as shown in FIG. 4B. These splines have slot 198 which accepts section 199 of tabs 197. Cover 104 is formed with annular, or ring, segment 191 connected to the cover body by sections 199. When sections 199 are inserted axially in slots 198, ring 191 radially surrounds the outside circumference of housing 102 to prevent radial expansion of the housing. Also, to provide clearance past indents 193, separator plates 182 are formed with complimentary notches 189.

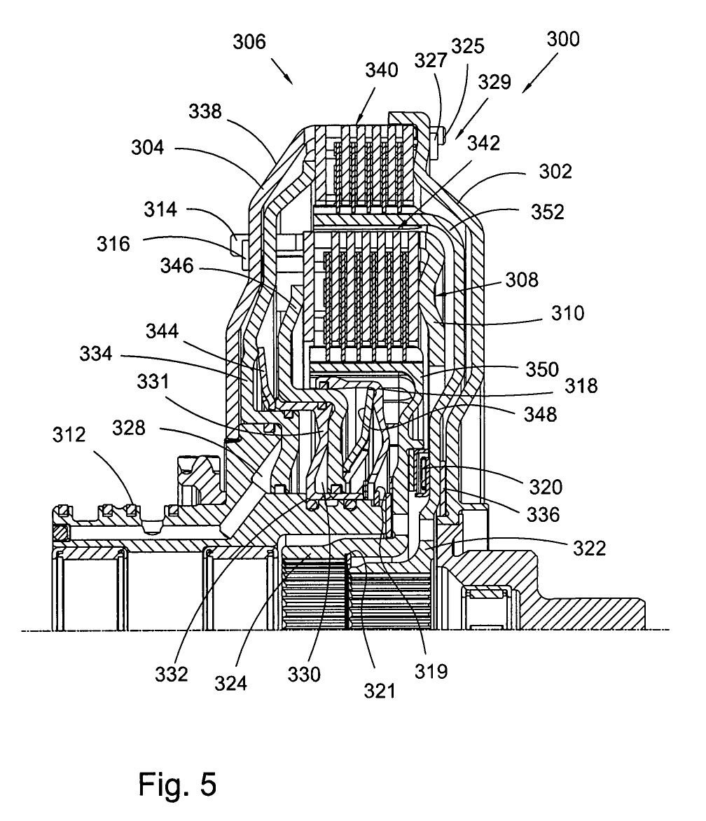

FIG. 5 is a cross-sectional view of double clutch 300.

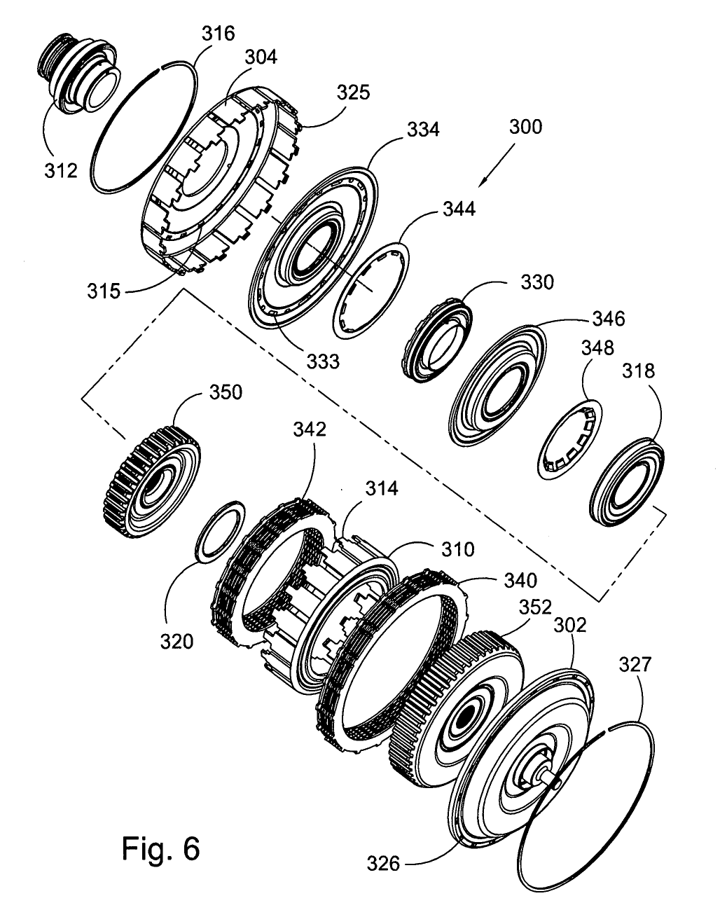

FIG. 6 is a back perspective exploded view of double clutch 300.

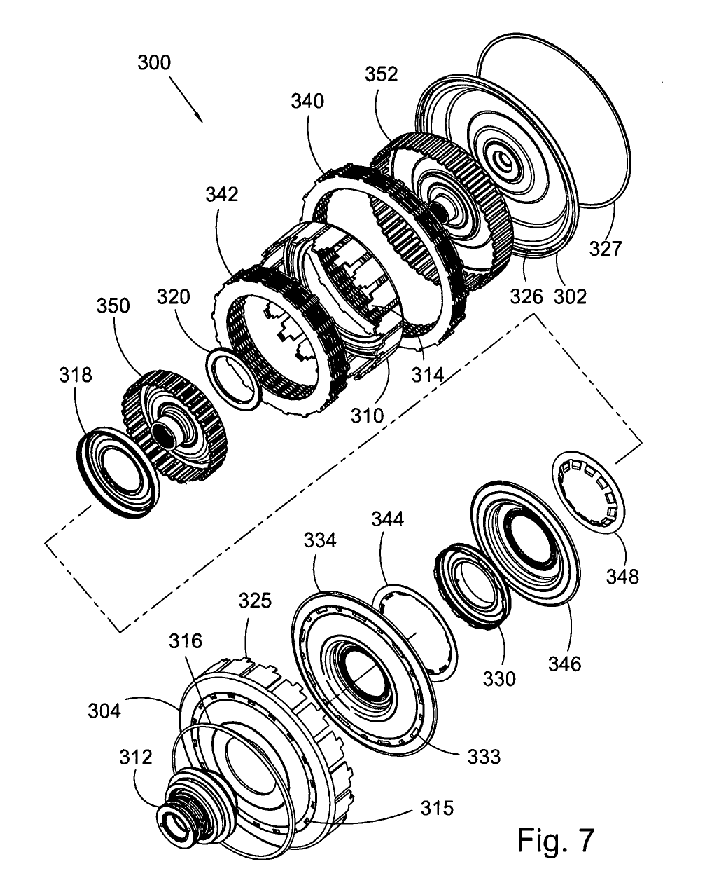

FIG. 7 is a front perspective exploded view of double clutch 300. The following should be viewed in light of FIGS. 5 through 7. Clutch 300 includes cover 302 and housing 304 for outer clutch 306. Inner clutch 308 includes housing 310. However, rather using a housing to transfer torque from manifold 312 to housing 310, housing 310 is engaged directly with housing 304 through tabs 314 axially inserted through openings 315 in the cover and held by retaining element 316. In some aspects, the retaining element is snap ring 316. Thus, the inner cover can be eliminated. Further, this arrangement eliminates the necessity of carrying engine torque through a weld between outer housing 304 and fluid manifold 312. The only torque that is carried through the weld is the relatively low torque required for the transmission pump. Thus, the complexity and cost of the outer housing and manifold connection is reduced.

The function of the inner cover for clutch 308 is performed by inner sealing plate 318, which is smaller and lighter, reducing the cost, weight, and size of clutch 300. In some aspects the functions of the inner sealing plate and the outer release spring are combined into a single component. Instead of a crimped connection, inner piston sealing plate 318 is held by snap ring 319. Assembly 300 includes the nested sealing design shown in FIG. 1.

Single bearing 320 reacts the thrust forces from the helical gears in the transmission (not shown). Combined with snap rings on both input shafts (not shown), for example, ring 321, the thrust bearing prevents the gears on the input shafts from disengaging from the mating transmission gears. The thrust bearing is located between the radially disposed segments of output hubs 322 and 324.

In addition, the thrust paths for clutches 306 and 308, during clutch apply, is balanced, similar to the arrangement described in FIG. 1. Housing 304 is connected to cover 302 through tabs 325 that extend through openings 326 in the cover and are held axially by retaining element 327. In some aspects, element 327 is a snap ring. When clutch 306 is applied, force is applied across the clutch to cover 302. Fluid pressure from apply chamber 328 creates a force on housing 304, opposite the force on cover 302. However, the forces on cover 302 and housing 304 communicate and balance across connection 329 between the cover and housing. Torque is transferred from cover 302 to housing 304 via tabs 325. Housing 304 transfers torque to housing 310 via tabs 315. When clutch 308 is applied, force is applied across the clutch to housing 310. There is no inner cover for clutch 308 and the force transfers along housing 310. Tabs 314 extend through openings 315 in housing 304 and snap ring 316 axially fixes the tabs. That is, snap ring 316 prevents the tabs from slipping back inside housing 304. As a result, the thrust load carried by housing 310 is transferred to the snap ring, which is urged against outer surface 338 of housing 304, and transfers the thrust load to housing 304. Fluid pressure from apply chamber 330 is transferred into the fluid manifold by axial contact between sealing plate 331 and the fluid manifold, for example at radial step 332 in the fluid manifold. Axial force from the sealing plate transfers to the fluid manifold and into outer housing 304, where it reacts the axial force from the clutch apply exerted by the inner piston plate. Tabs 314 also pass through slots 333 in piston plate 334.

The outer housing cover is installed after assembly with the transmission. The assembly method includes the steps of sliding clutch 300 onto the outer transmission shaft until snap ring 321 on outer output hub 324 contacts the outer input shaft, preloading the assembly by applying an axial force to inner output hub 322, inserting select-fit washers (not shown) as needed onto the inner input shaft adjacent to the inner input hub, installing a snap ring (not shown) onto the inner output shaft to retain the clutch assembly, inserting thrust washer 336 onto outer cover 302 adjacent to the inner output hub, and installing outer cover 302 and snap ring 316.

It should be understood that any means known in the art, for example, complimentary splines and notches can be used to connect clutch packs 340 and 342 to housings 304 and 310, respectively. In addition, in some aspects, a tab and slot arrangement as described in the commonly assigned U.S. Provisional Patent Application No. 60/775,622, titled “CLUTCH HOUSING WITH OPENINGS TO ENGAGE A CLUTCH PLATE, filed Feb. 22, 2006, can be used. To improve durability at high rotational speeds, the clutch pack interfaces are designed with components that reduce radial growth. The outer cover has a small lip that helps contain the long axial protrusion formed in the outer housing. The inner housing is limited to the slot clearance between the inner housing tabs and the outer housing slots. Therefore, durability at high speeds is improved.

The present invention also includes a method of assembling a clutch apparatus. Returning to FIGS. 1 and 3A through 4C; clutch apparatus 100 is an example of a clutch apparatus assembled by a present invention method. A first step axially inserts a radial extension, for example, extension 197, for a clutch cover, for example, cover 104, through a recess formed by a spline, for example, spline 192, in a clutch housing, for example housing 102. A second step forms a first radial indent, for example, indent 195 in the spline. The first indent is axially aligned with the first radial extension. In some aspects, the method forms a second radial indent, for example, indent 193, in the first spline and axially inserting a radial extension includes engaging the second indent with the radial extension.

In some aspects, the method forms a hole, for example, hole 194, between the second radial indent and an end of the housing prior to forming the first radial indent; or the method forms a chamfer, for example, chamfer 196, in a radial end of the radial extension and forming a first radial indent in the first spline includes urging the first radial indent against the chamfer. In some aspects, the housing is configured to transmit torque in a direction, for example, direction 181, and the method includes rotating the housing in the direction until the first radial extension contacts the housing, for example at radial edge 179.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A clutch apparatus, comprising:
a first bearing connected to a front side of said clutch apparatus; and,
a second bearing connected to a cover for said clutch apparatus, wherein said first bearing is arranged to be piloted on a front cover for a transmission and said second bearing is arranged to be piloted on a case for said transmission.

2. The clutch apparatus of claim 1 wherein said first and second bearings are arranged to center said clutch apparatus with respect to a longitudinal axis for said transmission.

3. The clutch apparatus of claim 1 wherein said front side further comprises a first housing and said clutch apparatus further comprising first and second clutches with first and second clutch carriers, respectively, wherein said second clutch further comprises a second housing, said transmission further comprises first and second input shafts arranged to be rotationally connected to said first and second clutches, respectively, and centered with respect to a longitudinal axis for said transmission, and said first and second input shafts are arranged to center said first and second clutch carriers, respectively, with respect to said first and second housings, respectively.

4. The clutch apparatus of claim 1 further comprising a fluid manifold and at least one bearing rotationally connected to said manifold and arranged to center said manifold, wherein said at least one bearing is disposed radially outside said manifold.

5. The clutch apparatus of claim 1 wherein said front side further comprises an input hub arranged to be engaged with a flywheel having a dampening element and connected to an engine and wherein said engagement of said input hub and said flywheel is arranged to compensate for misalignment between said transmission and said engine.

6. A clutch apparatus, comprising:
first and second radially disposed elements; and
a first sealing element disposed between said first and second radially disposed elements and forming a seal between said first and second radially disposed elements, wherein said first and second radially disposed elements form at least a portion of a first sealed fluid chamber in said clutch apparatus.

7. The clutch apparatus of claim 6 further comprising a clutch and wherein said first radially disposed element is a cover for said clutch, said second radially disposed element is a piston plate for said clutch, and said first sealed chamber is arranged to control displacement of said piston plate.

8. The clutch apparatus of claim 6 further comprising: a third radially disposed element and a second sealing element disposed between said first and third radially disposed elements and forming a seal between said first and third radially disposed elements, wherein said first and third radially disposed elements form at least a portion of a second sealed fluid chamber in said clutch.

9. The clutch apparatus of claim 8 further comprising first and second clutches and wherein said first radially disposed element is a cover for said first clutch, said third radially disposed element is a piston plate for said second clutch, and said second sealed chamber is arranged to control displacement of said piston plate.

10. The clutch apparatus of claim 8 wherein said first and second sealed fluid chambers are arranged to minimize a difference in dynamic pressure across said first radially disposed element.

11. The clutch apparatus of claim 8 further comprising: a fourth radially disposed element and a third sealing element disposed between said third and fourth radially disposed elements and forming a seal between said third and fourth radially disposed elements, wherein said third and fourth radially disposed elements form at least a portion of a third sealed fluid chamber in said clutch.

12. The clutch apparatus of claim 11 further comprising a clutch and wherein said fourth radially disposed element is a cover for said clutch, said third radially disposed element is a piston plate for said clutch, and said third sealed chamber is arranged to control displacement of said piston plate.

13. The clutch apparatus of claim 11 wherein said second and third sealed fluid chambers are arranged to minimize a difference in dynamic pressure across said third radially disposed element.

14. The clutch apparatus of claim 11 further comprising a fifth radially disposed element and a fourth sealing element disposed between said second and fifth radially disposed elements and forming a seal between said second and fifth radially disposed elements, wherein said second and fifth radially disposed elements form at least a portion of a fourth sealed fluid chamber in said clutch.

15. The clutch apparatus of claim 15 further comprising a clutch and wherein said second radially disposed element is a piston plate for said clutch and said fourth sealed chamber is arranged to control displacement of said piston plate.

16. The clutch apparatus of claim 14 wherein said first and fourth sealed fluid chambers are arranged to minimize a difference in dynamic pressure across said second radially disposed element.

17. The clutch apparatus of claim 14 wherein said fifth radially disposed element comprises an opening in fluid communication with said first and fourth chambers and wherein a size and radial location of said opening are selected to control fluid pressure on said second radially disposed element.

18. A clutch apparatus, comprising:
a first clutch housing with a first plurality of splines proximate an axial end; and,
a first clutch cover with a first plurality of radial extensions rotationally engaged with said first plurality of splines.

19. The clutch apparatus of claim 18 further comprising a clutch and a first fluid chamber at least partially enclosed by said first clutch cover, wherein said clutch comprises said first clutch housing and clutch cover, wherein in a closed position, said clutch exerts a first force on said first housing and fluid in said first fluid chamber exerts a second force on said first cover and wherein said first and second forces are in communication across said connection of said first housing and cover.

20. The clutch apparatus of claim 19 wherein said first and second forces are substantially in balance across said first housing and cover.

21. The clutch apparatus of claim 18 further comprising a torque transmission path between said first housing and said first cover through said first plurality of splines and said first plurality of radial extensions.

22. The clutch apparatus of claim 18 further comprising a rotatable element and a second clutch cover, wherein said first and second clutch covers are rotationally connected to said rotatable element.

23. The clutch apparatus of claim 22 further comprising a second clutch housing with a second plurality of splines proximate an axial end, wherein said second clutch cover comprises a second plurality of radial extensions rotationally engaged with said second plurality of splines.

24. The clutch apparatus of claim 23 further comprising a torque transmission path between said second housing and cover through said second plurality of splines and said second plurality radial extensions.

25. The clutch apparatus of claim 18 wherein at least one spline in said first plurality of splines further comprises an axial slot open at said axial end for said first housing, wherein said first cover includes an annular segment forming an outer circumference of said first cover, wherein said annular segment is connected to said first cover by at least one radial section, and wherein said at least one radial section is disposed is said at least one axial slot.

26. The clutch apparatus of claim 25 wherein said first plurality of splines comprises an outer circumference and said annular segment comprises an inner circumference in contact with said outer circumference.

27. The clutch apparatus of claim 18 wherein at least one spline in said first plurality of splines further comprises first and second radial indents and wherein at least one radial extension in said first plurality of radial extensions is disposed axially between said first and second radial indents.

28. The clutch apparatus of claim 18 wherein one of said first housing and cover is arranged to receive torque and to transfer said torque to the other of said housing and cover through said plurality of splines.

29. A clutch apparatus, comprising:
a housing for a clutch, said housing with an axial end;
a cover for said clutch, said cover connected to said housing at said axial end; and,
a fluid chamber at least partially enclosed by said cover, wherein in a closed position, said clutch exerts a first force on said housing and fluid in said fluid chamber exerts a second force on said cover and wherein said first and second forces are in communication across said connection of said housing and cover.

30. The clutch apparatus of claim 29 wherein said first and second forces are substantially in balance across said housing and cover.

31. The clutch apparatus of claim 29 wherein said housing comprises a plurality of splines proximate said axial end and said cover comprises a plurality of radial extensions rotationally engaged with said plurality of splines.

32. A clutch apparatus, comprising:
a first housing for a first clutch;
a second housing for a second clutch, said first housing connected to said second housing;
a rotatable element, wherein said first housing is connected to said rotatable element; and,
a fluid chamber for said second clutch, wherein in a closed position for said second clutch said second clutch exerts a first force in a first direction on said second housing and said second housing transfers said first force to said first housing, and fluid in said fluid chamber exerts a second force, in a second direction opposite said first direction, on said first housing through said rotatable element.

33. The clutch apparatus of claim 32 wherein said first housing transfers said first force to said rotatable element and said first and second forces are in balance across said rotatable element.

34. The clutch apparatus of claim 32 further comprising a snap ring connected to said second housing and in contact with an outer surface of said first housing.

35. The clutch apparatus of claim 32 wherein said rotatable element is a fluid manifold.

36. A clutch apparatus, comprising:
a first hub connected to a first clutch carrier, having a radial extension, and arranged for rotational connection to a transmission input shaft, wherein said input shaft is arranged to engage said radial extension;
a second hub connected to a second clutch carrier;
an input hub arranged for rotational connection to an engine; and
first, second, and third bearings, wherein said first bearing is axially disposed between said first and second hubs, said second bearing is axially disposed between said input hub and said second hub, and said third bearing is connected to said input hub and arranged to contact a transmission cover and wherein a torque path is formed from said shaft through said radial extension, said first hub, said first bearing, said second hub, said second bearing, said input hub, and said third bearing to said transmission cover.

37. The clutch apparatus of claim 36 wherein said radial extension is a snap ring connected to said first hub.

38. A method of assembling a clutch apparatus, comprising the steps of:
axially inserting a radial extension for a clutch cover through a recess formed by a first spline in a clutch housing; and,
forming a first radial indent in said first spline, said first indent axially aligned with said first radial extension.

39. The method recited in claim 38 further comprising forming a second radial indent in said first spline and wherein axially inserting a radial extension further comprises engaging said second indent with said radial extension.

40. The method recited in claim 39 further comprising forming a hole between said second radial indent and an end of said housing prior to forming said first radial indent.

41. The method recited in claim 38 further comprising forming a chamfer in a radial end of said radial extension and wherein forming a first radial indent in said first spline further comprises urging said first radial indent against said chamfer.

42. The method recited in claim 38 wherein said housing is configured to transmit torque in a direction and said method further comprising rotating said housing in said direction until said first radial extension contacts said housing.

43. A clutch apparatus, comprising:
a first housing for a first clutch, said first housing with a plurality of openings;
a second housing for a second clutch, said second housing with a plurality of axial extensions disposed in said plurality of openings, wherein one of said first and second housings is arranged to receive torque and transmit said torque to the other of said first and second housings through said plurality of axial extensions.
